(19) United States
(12) Patent Application Publication
(10) Pub. No.: US 2013/0050469 A1
(43) Pub. Date: Feb. 28, 2013

(54) Defect Inspection Apparatus

(71) Applicants: Masayuki TAKEZAWA, Hitachinaka (JP); Dai FUJII, Tokai (JP)

(72) Inventors: Masayuki TAKEZAWA, Hitachinaka (JP); Dai FUJII, Tokai (JP)

(73) Assignee: Hitachi High-Technologies Corporation, Tokyo (JP)

(21) Appl. No.: 13/570,325

(22) Filed: Aug. 9, 2012

(30) Foreign Application Priority Data
Aug. 29, 2011 (JP) 2011-185460

(51) Int. Cl. G06K 9/78; H04N 7/18

(52) U.S. Cl. 348/92; 382/149; 348/E07.085

(57) ABSTRACT

Provided is a defect detection apparatus capable of scalably improving processing performance for image processing, even though a plurality of multi-core processors are used therein. The defect detection apparatus comprises: an imaging unit for taking images of a sample forming a pattern, a dividing part 4b for dividing image data taken by the imaging unit into a plurality of image data blocks, and a parallel processing unit 5 for parallelly performing pieces of a defect detection processing for the plurality of the image data blocks to detect a defect in the pattern. Herein, the parallel processing unit uses a plurality of multi-core processors having a plurality of cores. The defect inspection processing of the image data block is performed per the multi-core processor.

### CROSS REFERENCE TO RELATED APPLICATIONS

This application claims the foreign priority benefit under Title 35, United State Code, 119 (a)-(d) of Japanese Patent Application No. 2011-185460, filed on Aug. 29, 2011 in the Japan Patent Office, the disclosure of which is herein incorporated by reference in its entirety.

### BACKGROUND OF THE INVENTION

1. Technical Field

The present invention relates to a defect inspection apparatus for inspecting a defect in a pattern formed on a sample and an image processor used in the defect inspection apparatus.

2. Description of Background Art

A defect inspection apparatus has been used for inspecting a fine defect in a pattern created on a surface of a sample. The sample includes a semiconductor wafer, a display, a photomask and the like. The defect inspection apparatus inspects a pattern defect by taking an image of the pattern on the sample to acquire image data thereof, performing image processing of the image data to detect a defect, extracting features of the defect from the detected defect, and then outputting the features as defect data. Herein, the features of the defect include coordinates, a shape, a size, a type thereof and the like.

As a defect inspection apparatus, there has been known an apparatus enabling a high-speed image processing by performing parallel processing. Such a defect inspection apparatus can take large quantities of image data of a semiconductor wafer by using, for example, an image sensor to acquire data of the images thereof, divide the acquired data of the images into image data blocks of a predetermined size, and then perform parallel processing of the image data block by using a plurality of processors (see Japanese Unexamined Patent Application Publications Nos. 2008-286586 and 2010-216963, especially). Moreover, the recent mainstream of processors has been changed in which a multi-core processor is practically utilized to promote downsizing, power saving and price reduction of the products having the processors.

A pattern formed on a surface of a sample such as a semiconductor wafer has become finer. This caused an amount of image data to be enormously increased and thus result in a requirement for a longer time of processing the image data. Therefore, to suppress such a longer time required for the image processing, increase in the number of cores has been acceleratively promoted with respect to a multi-core processor.

However, Amdahl's law has demonstrated that the processing performance of image processing is not proportional to the number of cores. In the meantime, assuming that there is a defect inspection apparatus which can linearly increase or decrease parameters substantially proportional to the processing performance of image processing (that is, have scalable performance), besides the number of cores, such defect inspection apparatus becomes greatly useful since the processing performance can be scalably improved in accordance with the refinement of the pattern.

### SUMMARY OF THE INVENTION

Therefore, an object of the present invention for solving the aforementioned drawbacks is to provide a defect inspection apparatus which can scalably improve the processing performance of image processing even if the defect inspection apparatus includes a multi core processor.

Further, another object of the present invention is to provide an image processor used in the defect inspection apparatus.

The present invention relates to a defect inspection apparatus comprising: an imaging unit for taking images of a sample on which surface pattern is formed; a dividing unit for dividing data of the images acquired by the imaging unit into a plurality of image data blocks; and a parallel processing unit for parallelly performing a defect detection processing to detect a defect of the pattern. The parallel processing unit uses a plurality of multi-core processors respectively having two or more cores.

According to the present invention, a defect inspection apparatus which can scalably improve a processing performance of image processing even if a multi-core processor is used therein, as well as an image processor used in the defect inspection apparatus may be provided.

### BRIEF DESCRIPTION OF THE DRAWINGS

FIG. 1 is a block diagram showing a defect inspection apparatus according to an embodiment of the present invention.

FIG. 2 is a block diagram (or part 1) showing a whole control unit and a multi processor unit, which construct an image processor included in the defect inspection apparatus according to an embodiment of the present invention.

FIG. 3 is a block diagram (or part 2) showing a whole control unit and a multi processor unit, which construct an image processor included in the defect inspection apparatus according to an embodiment of the present invention.

FIG. 4 is a flow chart (or part 1) showing a defect inspection method using the defect inspection apparatus in an embodiment of the present invention.

FIG. 5 is a flow chart (or part 2) showing a defect inspection procedure using the defect inspection apparatus in an embodiment of the present invention.

FIG. 6 is a block diagram (or part 1) showing a defect inspection apparatus according to a second embodiment of the present invention.

FIG. 7 is a block diagram (or part 2) showing a whole control unit and a multi processor unit, which construct an image processor included in the defect inspection apparatus according to the second embodiment of the present invention.

FIG. 8 is a block diagram (or part 3) explaining exemplary types of a packet according to the second embodiment.

### DETAILED DESCRIPTION OF THE PREFERRED EMBODIMENT

Next, embodiments of the present invention will be described in detail hereinafter with reference to the drawings. Note same symbols/numerals are used for common parts through the figures and the repeated descriptions thereof will be omitted.

### First Embodiment

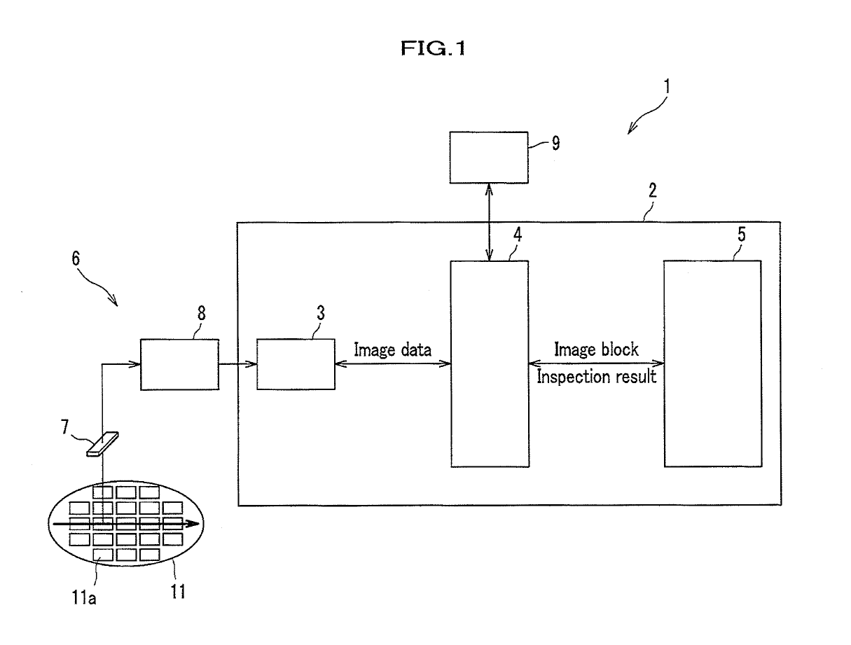

FIG. 1 shows construction of a defect inspection apparatus 1 according to an embodiment of the present invention. The defect inspection apparatus 1 generally comprises an image acquiring part (or imaging unit) 6, image processing unit (or an image processor used in the defect inspection apparatus) 2, and an external device 9. The defect inspection apparatus 1 can inspect a sample 11 such as a semiconductor wafer as shown in FIG. 1. Further, the defect inspection apparatus 1 is capable of inspecting a display such as a liquid crystal display, a photomask used for producing a semiconductor wafer and a display, and the like other than a semiconductor wafer. Note that a plurality of semiconductor chips 11a are formed on the semiconductor wafer (a sample) 11. Those semiconductor chips 11a are arranged into a matrix form.

The image acquiring part 6 takes an image of a pattern formed on the surface of the semiconductor chip 11a as well as an image of a defect created on the pattern for some reason. The image acquiring part 6 includes a sensor 7 and an A/D convertor circuit 8. The sensor 7 may include a Time Delay and Integration (TDI) sensor, a line sensor such as a CCD sensor and the like. The sensor 7 receives light from the surface of the semiconductor wafer 11 (i.e., reflected light) to acquire an image signal. The A/D convertor circuit 8 can convert the image signal from an analog signal to a digital signal. The sensor 7 can scan a surface of the semiconductor wafer (or a sample) 11 to acquire an image signal and thus acquire two-dimensional image data over the entire surface of the semiconductor wafer 11 (or semiconductor chips 11a). The acquired image data can be input from the image acquiring part 6 to the image processing unit 2.

The External device 9 includes an input device, a display device and a memory device, which are not shown in the figures. The input device and the display device constitute a user interface (e.g., a graphical user interface (GUI)). Programs such as an operation program and a sequence program and control data such as setting values and a check condition (i.e., operation parameters) used in a defect inspection are input from the input device to the memory device in the external device 9 and the image processing unit 2 via the user interface. The memory device in the external device 9 stores the programs, the control data (i.e., operation parameters) and inspection results acquired through the defect inspection. Herein, the image processing unit 2 detects a defect from image data and then extracts features of the defect (that is, coordinates, a shape, a size, a type thereof and the like) thereby to create the defect data as the inspection results acquired through the defect inspection. The external device 9 displays the defect data on the display device to prompt an operator to identify the type of each defect. Then, the operator identifies the defect type in accordance with the defect data displayed on the display device and then inputs and specifies the defect type by using the input device. The specified defect type is also stored in the memory device as the inspection results.

The image processing unit 2 includes an image memory 3 for storing the image data input from the image acquiring part 6, a multiprocessor unit (or parallel processing unit) 5 for performing image processing of the image data, and a whole control unit 4 for controlling the whole operation in the defect inspection apparatus 1 including the image processing unit 2, the image acquiring part 6 and the external device 9. The multiprocessor unit (or parallel processing unit) 5 has two or more multi-core processors.

The image memory 3 has a memory space for recording image data of the plurality of semiconductor chips 11a. The whole control unit 4 has a function for cutting image data blocks out from the image memory 3, thereby to divide the image data into a plurality of image data blocks and distribute the blocks. The image data blocks are cut out on the basis of the area calculated by the whole control unit 4 and then input to the multiprocessor unit 5.

The whole control unit 4 transmits/receives data, for example, transmitting image data blocks and receiving inspection results with the multiprocessor unit 5. Further, the whole control unit 4 controls the image data accumulated in the image memory 3. The whole control unit 4 loads and sets programs (e.g., an operation program and a sequence program) and control data such as setting values and inspection conditions (i.e., operation parameters) input from the external device 9 into a predetermined processor (or the multi processor unit 5). Then, the whole control unit 4 operates the processor (or the multi processor unit 5) to execute a defect detection processing (i.e., image processing) on the basis of the control data. Finally, the whole control unit 4 receives an inspection result of the image processing from the multiprocessor unit 5 and transmits the inspection result to the external device 9.

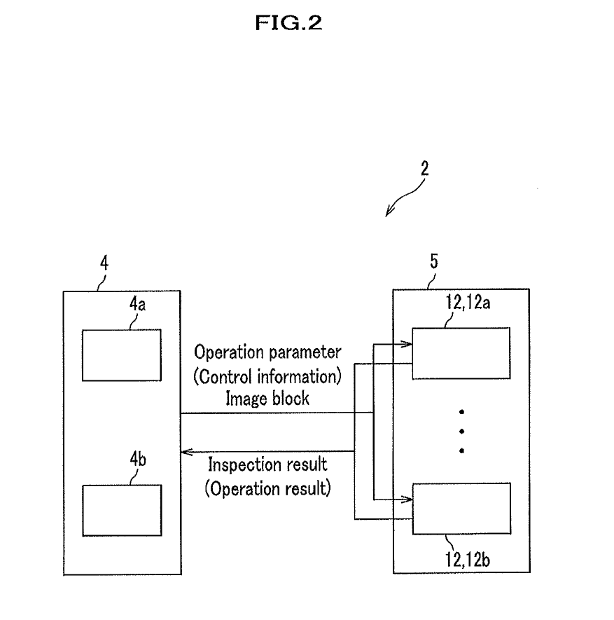

FIG. 2 is a block diagram showing a construction of the whole control unit 4 and the multiprocessor unit 5 included in the image processing unit 2. The whole control unit 4 has a processing control part 4a and a division part 4b. The multiprocessor unit 5 includes two or more multi core processors 12 (12a, 12b) each having a plurality of cores.

The processing control part 4a loads and sets programs (e.g., an operation program and a sequence program) and control data such as setting values and inspection conditions (i.e., operation parameters) into a multi-core processor 12 (12a, 12b) in the multi processor unit 5. The processing control part 4a then operates the multi-core processors 12 (12a, 12b) to execute a defect detect processing (or image processing) on the basis of the control data.

The division part 4b divides image data taken by the image acquiring part 6 (see FIG. 1) and then stored in the image memory 3 into a plurality of image data blocks, thereby transmitting the data blocks to the multi-core processors 12 (12a, 12b). The multi-core processor 12 (12a, 12b) executes a defect detection processing (or image processing) of the received image data blocks to create an inspection result (or an operation result) and then transmits the inspection result to the whole control unit 4.

The multiprocessor unit (or parallel processing unit) 5 includes a plurality of multi-core processors 12 (12a, 12b). The plurality of multi-core processors 12 (12a, 12b) execute in parallel the defect detect processing (or image processing) of the image data blocks divided and distributed by the division part 4b so as to execute the programs in parallel according to the operation parameters. The multi-core processors 12 (12a, 12b) acquires an inspection result (or operation result) as the processing result and transmits the result into the whole control unit 4. Each of the plurality of multiprocessors 12 (12a, 12b) constituting the multiprocessor unit 5 has the given number of cores formed inside one semiconductor substrate (or chip). Accordingly, the processing ability of the defect inspection device 1 can be scalably increased or decreased by changing the number of multi-core processors 12 (12a, 12b).

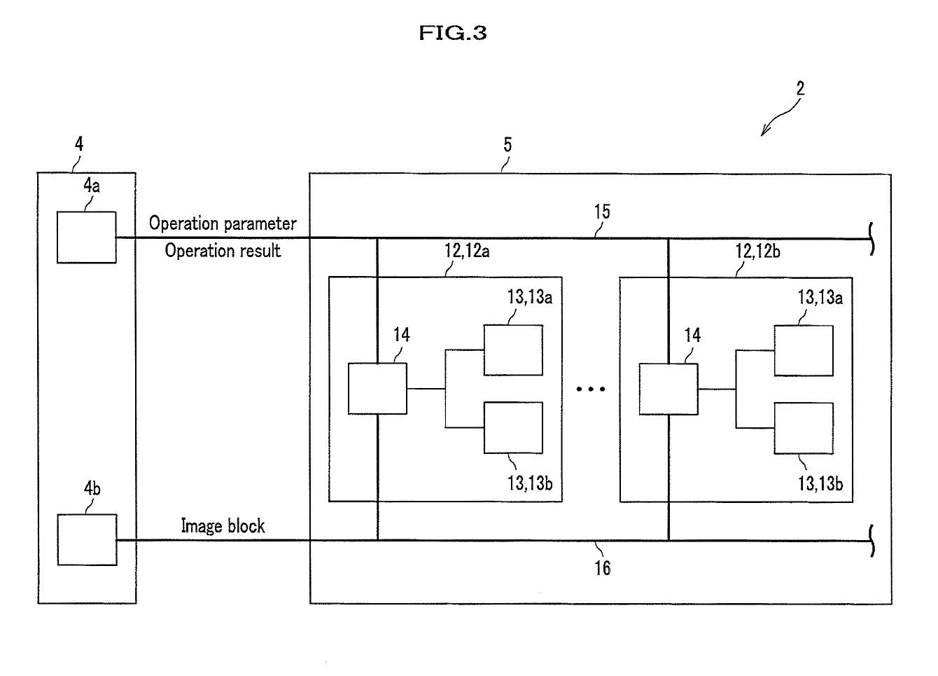

FIG. 3 shows a relationship between the whole control unit 4 and the multiprocessor unit 5 included in the image processing unit 2. The multi processor unit 5 has the plurality of multi core-processors 12 (12a, 12b) each of which has a plurality of cores (i.e., a control core 14 and operation cores 13 (13a, 13b)). In an example shown in FIG. 3, each multi-core processor 12 (12a, 12b) has one control core 14. However, the number of control cores may be not limited to this example, while a plurality of control cores may be included. Further, in the example shown in FIG. 3, each multi-core processor has two operation cores 13 (13a, 13b). However, the number of operation cores may be not limited to this example, while only one or more than two operation cores may be included. The control core 14 is directly connected to each of the operation cores 13 (13a, 13b).

The control core 14 receives an image data block from division part 4b via an image bus 16. Each of the operation cores 13 (13a, 13b) performs the defect detection processing of the image data block. The image data block for performing a defect detection processing by the operation cores 13 (13a, 13b) is prepared via the control core 14.

The defect detection processing mainly includes delay processing and difference detection processing. The delay processing delays the image data block which was previously input. The delay processing inputs the previously input image data block at the same timing as the later input data is inputted to the difference detection processing. The difference detection processing detects a difference in the signal intensity between a pixel in a former input image data block and the same pixel in a later input image data block. Then, the difference detection processing determines whether a defect exists or not based on the detected differences. In this determination of existence of a defect, a threshold is set for determining the existence of a defect based on the differences between the signal intensities of the pixels. Herein, the threshold is calculated on the basis of the above mentioned operation parameters by the operation cores 13 (13a, 13b).

Then, the control core 14 acquires the profiling values including a location of the pixel, that is, where the pixel identified having a defect (or determined to have a defect) is located inside the image data block and a signal intensity of the pixel, as inspection results (or operation results). Then, the control core 14 transmits the inspection results to the processing control part 4a.

The control core 14 performs other processings than the defect detection processing (or image processing). On the other hand, the operation cores 13 (13a, 13b) executes exclusively the defect detection processing (or image processing). In other words, the control core 14 executes the control processing necessary to the defect detection processing so that the operation cores 13 (13a, 13b) may exclusively execute the defect detection processing (or image processing). More specifically, the control core 14 receives operation parameters and image data block, which are the external control interruption.

In addition, as the processing sequence control, the control core 14 further divides the received image data block into further divided image data blocks, and each of which is distributed to one of a plurality of operation cores 13 (13a, 13b) and which are being processed in parallel. Furthermore, as the processing sequence control, the control core 14 divides one image data block among the received image data blocks (for example, one image data corresponding to one semiconductor chip 11a (see FIG. 1)) into different areas each having the above mentioned different threshold in the semiconductor chip 11a.

The control core 14 then distributes the divided image data blocks to the operation core 13a and the operation core 13b to each of which the different threshold was set in advance, thereby to make the operation cores 13 processing the respective divided image data blocks in parallel. Similarly, as the processing sequence control, the control core 14 divides the received image block data (for example, one image data corresponding to one semiconductor chip 11a (see FIG. 1)) into a memory area having a memory circuit and a logic area having a logic circuit in the semiconductor chip 11a.

Then, the control core 14 distributes the divided image data blocks to the operation cores 13 (13a, 13b) of having loaded beforehand the operation programs for executing the delay processing and the deference detection processing each using different type of algorithm in the memory area or in the logic area, thereby to make the operation cores 13 processing the divided data blocks in parallel. As the operation cores 13 (13a, 13b) can exclusively execute the defect detection processing (or image processing), the processing ability can be kept up at a high level. Further, as the plurality of operating cores 13 (13a, 13b) can perform the defect detection processing (image processing) in parallel, the processing ability will be enhanced. Moreover, if the plurality of operation cores 13a are arranged to perform the same pieces of the defect detection processing in parallel (for example, using the same operation parameters), the processing ability will be further enhanced.

Similarly, the plurality of operation cores 13b conduct the same pieces of the defect detection processing in parallel (for example, using the same operation parameters therebetween, but different operation parameters from those of the operation core 13a), allowing the processing ability to be enhanced.

As described above, the defect detection processing performed in the plurality of operation cores 13 (13a, 13b) can be varied depending on the intended use in respective operation cores 13 (13a, 13b), and thus a plurality of pieces of the defect detection processing suitable for the inspection object can be performed, resulting in outputting a plurality of output results. The control core 14 can selectively output the plurality of output results or output the results in a combined or integrated manner corresponding to an inspection target.

The control core 14 and the operation cores 13 (13a, 13b) constituting one multi-core processor 12 (12a or 12b) are formed together inside one semiconductor chip. This construction enables data transmitting and receiving at high-speed between the control core 14 and the operation cores 13 (13a, 13b).

The processing control part 4a in the whole control unit 4 is connected via a single common control bus 15 to the control cores 14 per each of the plurality of multi-core processors 12 (12a, 12b). Note that such a connection can be realized, but not limited to, via the control bus 15. Such a connection can also be realized by communication unit over a network or a combination of a bus and a network. This allows transmission and reception of operation parameters, operation results and the like to be achieved at high speed between the processing control part 4a and the plurality of control cores 14.

The division part 4b of the whole control unit 4 is connected via a single common image bus 16 to the control core 14 per each of the plurality of multi-core processors 12 (12a, 12b). Such a connection can be realized, but not limited to, via the image bus 16. Such a connection can also be realized by communication unit over a network or a combination of a bus and a network. This allows transmission and reception of the image data blocks to be achieved at high speed between the division part 4b and the plurality of control cores 14.

When a multi-core processor 12 is added in the multiprocessor unit 5, it is only necessary to connect the added multi-core processor 12 to the existing control bus 15 and image bus 16. When the number of multi-core processors 12 is decreased in a multiprocessor unit 5, it is only necessary to disconnect a target multi-core processor 12 from the control bus 15 and the image bus 16. As mentioned above, the number of multi-core processors 12 (12a, 12b) can be varied in this manner. Such scalability of a size enables the processing capacity of the defect detection apparatus 1 to be scalably increased or decreased.

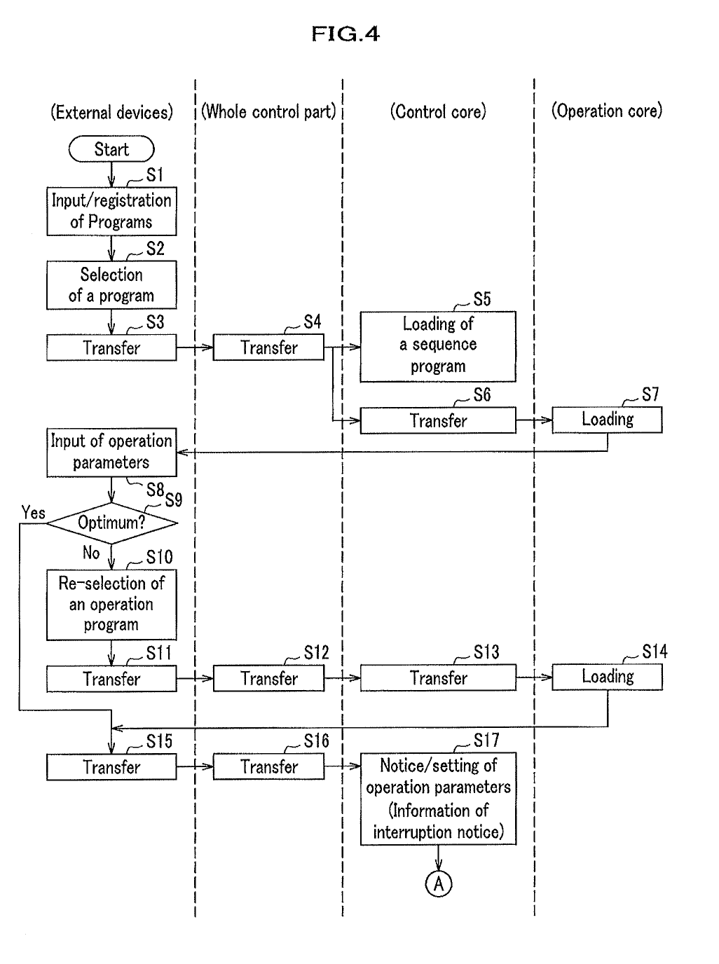

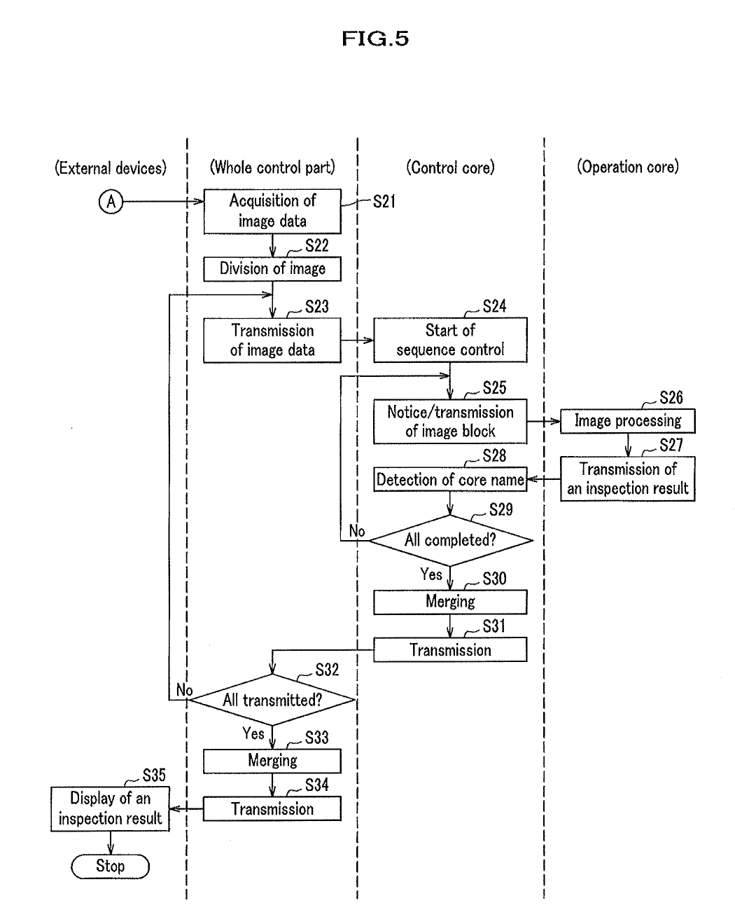

FIGS. 4 and 5 show exemplary flowcharts of defect inspection methods used in the defect inspection apparatus 1 in an embodiment of the present invention. Refereeing to each flowchart, will be explained the method comprising the steps relating to the external device 9 (see FIG. 1), the whole control unit 4, the control core 14 and the operation cores 13 (13a, 13b).

First, in a step S1, the external device 9 prompts an operator via a GUI to input an operation program executed by the operation cores 13 (13a, 13b) as well as a sequence program executed in the control core 14, thereby to register the operation program and the sequence program. Different operation programs may be registered per the operation cores 13a and 13b.

In a step S2, the external device 9 prompts the operator to select the operation program and a sequential program to be used in the following defect inspection. Then, the external device 9 stores the method on the selected operation program and the sequence program.

In a step S3, the external device 9 transfers the data on the selected operation program and the sequence program to the whole control unit 4.

In a step S4, the whole control unit 4 transfers the selected operation program and sequential program to the control core 14.

In a step S5, the control core 14 loads (or reads) the selected operation program and sequential program which have been selected and transferred.

In a step S6, the control core 14 further transfers the selected operation program, which has been selected and transferred, to the operation cores 13 (13a, 13b).

In a step S7, the operation cores 13 (13a, 13b) load (read) the operation program which has been selected and transferred.

In a step S8, the external device 9 prompts the operator via the GUI to input the operation parameters used when the operation program is executed. The external device 9 then stores the input operation parameters.

In a step S9, the external device 9 determines whether or not the operation program loaded on the operation cores 13 (13a, 13b) is appropriate for the operation parameters. For example, as operation parameters, coordinates and areas or the like of the memory area forming the memory circuit and logic area forming the logic circuit may be acquired in the semiconductor chip 11a. Preferably the operation program capable of detecting a defect well in the memory circuit is executed in the memory area. Further, preferably the logic circuit in the logic area executes the operation program capable of detecting a defect well.

In the step S9, it is determined whether or not the loaded operation program has appropriately selected for the operation parameters as described above. If the loaded operation program has a relationship correspondent to the operation parameters, proceed to a step S15, as it is an optimum program (in the step S9, Yes). Otherwise, there is no relationship correspondent to the operation parameters, proceed to a step S10, as it is not an optimum program (in the step S9, No).

In a step S10, the external device 9 selects again and stores an operation program corresponding to the input operation parameters.

In a step S11, the external device 9 transfers the readout operation program or data thereof to the whole control unit 4.

In a step S12, the whole control unit 4 transfers the readout operation program to the control core 14 via the control bus 15.

In a step S13, the control core 14 transfers the readout operation program to the operation cores 13 (13a, 13b).

In step S14, the operation cores 13 (13a, 13b) load (or read) the readout operation program.

In a step S15, the external device 9 transfers the operation parameters put in the step S8 to the whole control unit 4.

In a step S16, the whole control unit 4 transfers the input operation parameters to the control core 14 via the control bus 15.

In a step S17, the control core 14 gives notice to the operation cores 13 (13a, 13b) about the input operation parameters and sets those operation parameters on the operation program in the operation cores 13 (13a, 13b). If the operation parameters are not transferred and set to the operation cores 13 (13a, 13b), the control core 14 may give notice to the operation cores 13 (13a, 13b) about the data indicating that the control core 14 received the operation parameters (for example, notice of interruption data).

This allows a plurality of operation cores 13 (13a, 13b) to refer to the operation parameters stored in the control core 14 as common data.

Next, in a step S21 in FIG. 5, image data of the semiconductor wafer 11 are acquired by the image acquiring part 6. The image data are stored in the image memory 3 in the whole control unit 4. The division part 4b in the whole control unit 4 obtains the image data from the image memory 3.

In a step S22, the division part 4b in the whole control unit 4 divides the image data to create an image data block.

In a step S23, the division part 4b in the whole control unit 4 transmits (or distribute) the image data block to the respective control cores 14 respectively included in the plurality of multi-core processors 12 (12a, 12b) via the image bus 16.

In a step S24, the control core 14 is triggered by a reception of the image data block so as to start sequence control according to the loaded sequence program. A parallel processing will begin in the plurality of multi-core processors 12 (12a, 12b).

In a step S25, the control core 14 gives the operation cores 13 (13a, 13b) a notice about the reception of the image data block or the control core 14 transmits the received image data block to the operation cores 13 (13a, 13b). If the image data block is not sent to and stored in the operation cores 13 (13a, 13b), the operation core 14 may send notice about the reception of the image data block (for example, notice of interruption data) to the operation cores 13 (13a, 13b). This allows the plurality of operation cores 13 (13a, 13b) to refer to the image data block stored in the control core 14 as common data.

In a step S26, the plurality of operation cores 13 (13a, 13b) respectively execute the respectively loaded operation programs to perform image processing (or a defect detection processing) in parallel. For example, the image data block is further divided and distributed to the plurality of operation cores 13 (13a, 13b) by the control core 14 in the step S25 and then processed in parallel in the step S26.

Further, for example, in the step S25, the control core 14 divides the received image data block into the respective areas each having different thresholds in the semiconductor chip 11a, and distributes the divided data blocks to the control cores 13a and 13b to be assigned beforehand with different thresholds (or operation parameters). In this step S26, the image data blocks are processed in parallel by the control cores 13a and 13b.

Moreover, for example, in the step S25, the control core 14 divides the received image data block into the memory area forming a memory circuit and the logic area forming a logic circuit in the semiconductor chip 11a. Then, the control core 14 distributes the divided data blocks to the operation cores 13a and 13b which have loaded beforehand the operation programs for executing the delay processing and the difference detect processing having different algorism for using in the memory area and the logic circuit. Eventually, in the step S26, the distributed data blocks are processed in parallel the operation cores 13a and 13b.

In a step S27, the plurality of operation cores 13 (13a, 13b) transmit the inspection result on the location of the defect and the like acquired by performing the image processing (or the defect detection processing) to the control core 14.

In a step S28, the control core 14 detects respective core names (or identifiers) of the operation cores 13 (13a, 13b) from each of which the inspection result has been transmitted.

In a step S29, the control core 14 determines whether all the image data blocks have been inspected or not. If all the image data blocks have been inspected (in the step S29, Yes), then proceed to step S30. If all the image data blocks have not inspected yet (in the step S29, No), then return to the step S25. Herein, the divided image data blocks not yet transmitted are transmitted to the operation cores 13 (13a, 13b) which correspond to the core names (or identifiers) detected in the step S28, in the wait state for the processing.

In a step S30, the control core 14 integrates the inspection results received from the plurality of operation cores 13 (13a, 13b). More specifically, for example, the coordinates of the defect detected as the location data in the divided image data block may be converted to coordinates of the defect indicating a location in the image data block before dividing processing. The operation cores 13 (13a, 13b) may perform the above mentioned processing. Further, the control core 14 can sum up the total number of defects detected on the plurality of operation cores 13 (13a, 13b, or collect and edit the inspection results as the resultant data.

In a step S31, the control core 14 transmits the inspection result data which is collected up into a size defined by a parameter or the like in advance to the processing control part 4a in the whole control unit 4.

In a step S32, the processing control part 4a determines whether or not all the inspection results have been transmitted from the control core 14. If all the inspection results (in the step S32, Yes) have been transmitted, then proceed to a step S33. If all the inspection results (in the step S32, No) have not been transmitted yet, then return to the step S32. Herein, the un-transmitted image data blocks are transmitted to the multi-core processors 12 (12a, 12b) which detected the data in advance and are in the waiting state for the processing.

In a step S33, the processing control part 4a integrates the inspection results received from the plurality of multi-core processors 12 (12a, 12b). More specifically, the coordinates of the defect detected for the location in the image data block are converted into defect coordinates indicating a location in the image data (or in semiconductor wafer 11) before the dividing processing. The processing control part 4a may have each of the multi-core processors 12 (12a, 12b) execute those pieces of a processing.

Further, the processing control part 4a can integrate inspection results redundantly detected from the plurality of multi-core processors 12 (12a, 12b), or convert the inspection results to a file specifically formatted by parameters or the like.

In a step S34, the processing control part 4a transmits the inspection results integrated at a level of the image data (that is, of the semiconductor wafer 11) to the external device 9.

In a step S35, the external device 9 stores and then displays the inspection results to prompt the operator to check the results. The external device 9 stores checked input of the inspection results by the operator as well as the inspection results.

### Second Embodiment

Next, a second embodiment of the present invention will be explained. This embodiment mainly differs from the first embodiment in the following points.

The defect detection apparatus of this embodiment comprises:

(1) an image acquiring part arranged in a plurality of directions to a sample;

(2) a memory part having a sufficient capacity for storing images acquired by scanning the apparatus at least in a single direction; and

(3) a function of packetizing a plurality of images to be processed in the multi-core processor. Other aspects are the same as those of the first embodiment.

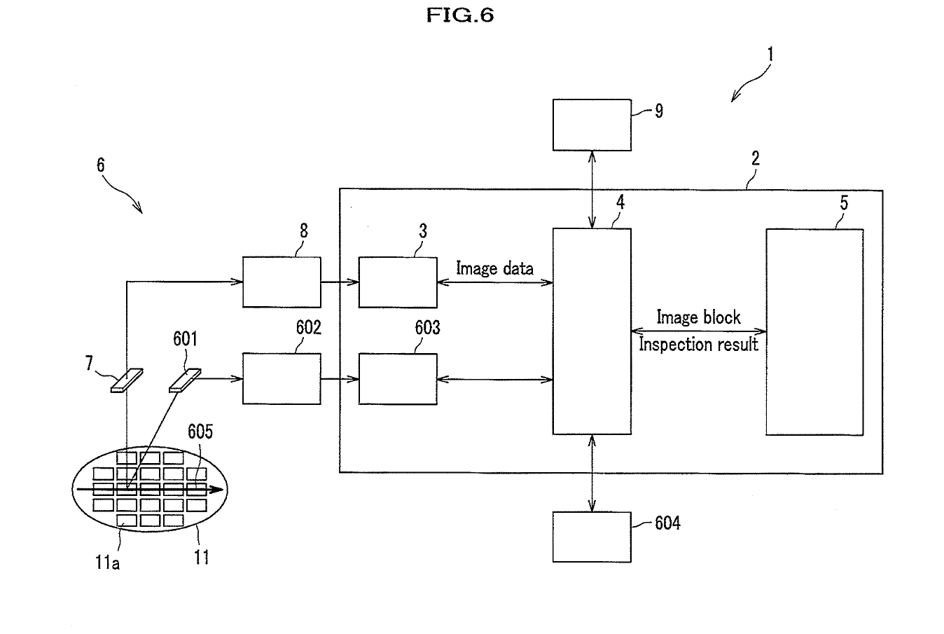

FIG. 6 is a diagram explaining the constitution of the devices and units of the present embodiment. According to the present embodiment, the defect detection apparatus comprises a sensor 601, an A/D convertor 602 and an image memory 603 in addition to the constitution of the first embodiment. In other words, the defect detection apparatus of the present embodiment comprises image acquiring parts arranged in plurality directions for the inspection target.

The whole control unit 4 is connected with an image memory part 604 having a sufficient capacity for storing data of images each acquired by single scanning 605. The image data acquired by a sensor 7 and a sensor 601 are to be stored in the image memory part 604 by the whole control unit 4.

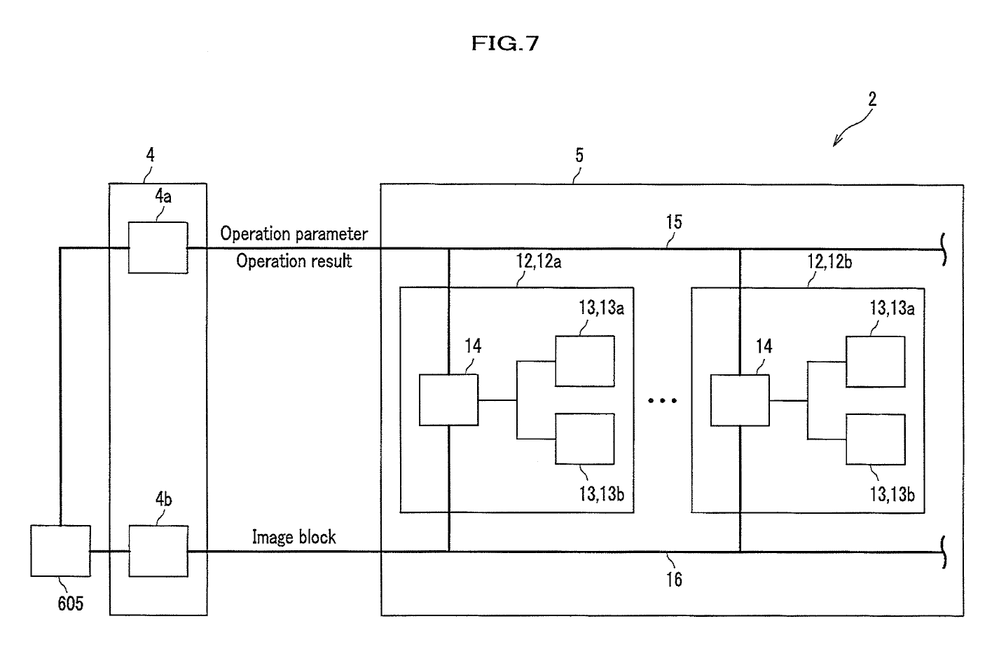

FIG. 7 is a diagram explaining a relationship between the whole control unit 4 and the multi processor unit 5 according to the present embodiment. The dividing part 4b divides image data stored in the image memory part 604 into a plurality of image data blocks, packetizes the plurality of image data blocks, and then transmits the packets comprised of the plurality of image data blocks to the multi-core processors 12 (12a, 12b) in the multi processor unit 5.

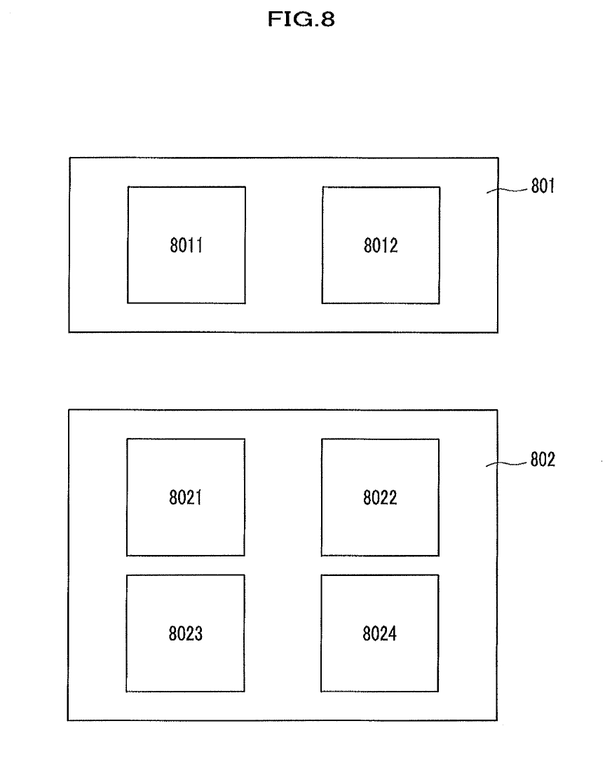

Several kinds of packets are available in the present embodiment. FIG. 8 is a diagram explaining examples of packet types according to the present embodiment. The packet 801 includes an image data block 8011 acquired by the sensor 7, and an image data block 8012 acquired by the sensor 601, both obtained from the same die.

The packet 802 includes an image data block 8021 on the first die acquired by the sensor 7, an image data block 8022 on a second die adjacent to the first die acquired by the sensor 7, an image data block 8023 on the first die acquired by the sensor 601, and an image data block 8024 on the second die acquired by the sensor 601. Control data on the image data block are added to each packet.

Next, the multi-core processors 12a, 12b according to the present embodiment will be explained. The control core 14 receives a series of packets transmitted from the dividing part 4b. The control core 14 refers to the control data added to the packet and reads out an appropriate program for processing the image data block contained in the packets transmitted from the processing control part or the memory in the control core. The readout operation program is loaded into the operation cores 13a, 13b. The control core 13a processes the image data block in accordance with the loaded operation program.

When the control core 14 receives the packet 801 in FIG. 8, first the control core 14 transmits the received image data block 8011 to the operation core 13a and the control core 14 also transmits the received image data block 8012 to the operation core 13b. The operation core 13a divides the image data block 8011 into a memory area and a logic area. The operation core 13a then processes the memory area by using a delay processing program and a difference detection program used for a memory circuit, which have been loaded in advance, and processes the logic area by using a delay processing program and a difference detection program used for a logic circuit, which have been loaded in advance. Similarly, the operation core 13b divides the image data block 8012 into a memory area and a logic area. The operation core 13b then processes the memory area by using a delay processing program and a difference detection program used for a memory circuit which have been loaded in advance, and processes the logic area by using a delay processing program and a difference detection program used for a logic circuit which have been loaded in advance.

Taking for an example of a dark-field type inspection apparatus for detecting scattering light as the defect inspection apparatus according to the embodiment, the dark-field-type inspection apparatus may have different image data blocks 8011, 8012 each other. Accordingly, the programs to be loaded in the operation cores 13a, 13b should take account of the differences occurred by the detection directions of the dark-field images. This may lead to different types of programs to be used.

Alternatively, the packet 801 may include two identical image data blocks to be processed with different programs respectively included in the operation cores 13a, 13b.

When the control core 14 in the multi-core processor 12a receives the packet 802 shown in FIG. 8, first the control core 14 transmits the received image data blocks 8021 and 8023 in the packet 802 to the operation core 13a and also transmits the image data blocks 8022 and 8024 in the packet 802 to the operation cores 13b. The operation core 13a performs matching processing to match the coordinates of the image data blocks 8021, 8023 with each other.

After having the matched coordinates by conducting the matching processing, the image data blocks 8021 and 8023 will be transmitted to the control core to perform the delay processing and the difference detection processing in the same methods as those for processing the packet 801. After having the matched coordinates by conducting the matching processing, the image data blocks 8022 and 8024 will be transmitted to other multi-core processors to perform the delay processing and the difference detection processing. Note that if the operation core 13a and the operation core 13b in the multi-core processor 12a have sufficient capacity to store the data of two image data blocks, the matching program, the delay processing program and the difference detection program, they may perform the delay processing and the difference detection processing following the matching processing.

Has been explained a case in which the packets 801 and 802 are processed. However, in this or any other case, the processing results can be stored in the memory part 604 or transmitted to the external device 9 via the whole control unit 4. Further, in this or any other case, the dividing processing into a memory area and a logic area may be conducted in the control core 14. The dividing part 4b can arbitrarily control timings to read a packet from the memory part 604 in any timing. Furthermore, the contents disclosed in the present embodiment may be applied to an inspection apparatus of so-called bright-field type.

What is claimed is:

1. A defect inspection apparatus comprising:
an imaging unit for taking an image of a sample having a pattern formed on a surface thereof;
a dividing part for dividing image data taken by the imaging unit into a plurality of image data blocks; and
a parallel processing unit including a plurality of multi-core processors each having a plurality of cores and parallelly performs a defect detection processing for a defect in the pattern with respect to each of the plurality of image data blocks, wherein
the plurality of cores include operation cores for executing the defect detection processing of the image data blocks and control cores for receiving the image data blocks from the dividing part, and
the image data block to which the operation core performs the defect detection processing is prepared by the control core.

2. The defect detection apparatus according to claim 1, wherein the imaging unit is composed of a plurality of sensors arranged in a plurality of directions to the sample, and
the defect detection apparatus further comprising:
a memory part for storing data of a plurality of dark-field images acquired by scanning the sample at least once, wherein
the dividing part transmits any of the plurality of dark-field image data in a packet,
the packet includes first dark-field image data and second dark-field image data,
the multi-core processor receives the packet,
the multi-core processor has a first operation core and a second operation core, and
the first operation core or the second operation core aligns a location of the first dark-field image data with a location of the second dark-field image data.

3. The defect inspection apparatus according to claim 2, wherein
the first dark-field image data and the second dark-field image data are involved with a first die,
the packet further includes third dark-field image data which are involved with a die adjacent to the first die and acquired by the first sensor and forth dark-field image data acquired by the second sensor,
the first operation core aligns the location of the first dark-field image data with the location of the second dark-field image data, and
the second operation core aligns the location of the first dark-field image data with the location of the second dark-field image data.

4. The defect inspection apparatus according to claim 3, wherein
the first operation core performs the defect detection processing for the first dark-field image data and the second dark-field image data which have been aligned with each other,
the second operation core performs the defect detection processing for the third dark-field image data and the forth dark-field image data which have been aligned with each other.

5. The defect inspection apparatus according to claim 3, further comprising other multi-core processors connected via a network, wherein the other multi-core processors perform the defect detection processing for the first dark-field image data and the second dark-field image data which have been aligned with each other.

6. The defect inspection apparatus according to claim 3 further comprising other multi-core processors connected via a network, wherein the other multi-core processors perform the defect detection processing for the third dark-field image data and the forth dark-field image data which have been aligned each other.

7. The defect inspection apparatus according to claim 1, wherein each of the multi-core processors performs the defect detection processing of the image block data.

8. The defect inspection apparatus according to claim 1, wherein the plurality of operation cores perform the defect detection processing at high speed by each operation core of parallelly performing the same defect detection processing therebetween.

9. The defect detection apparatus according to claim 1, wherein the plurality of operation cores perform different pieces of the defect detection processing from each other.

10. The defect inspection apparatus according to claim 1, wherein the defect detection processing performed per each of the plurality of operation cores is varied corresponding to the intended use, thereby to output a plurality of output results through performing the plurality of pieces of the defect detection processing suitable for an inspection target.

11. The defect inspection apparatus according to claim 10, wherein the plurality of output results are output selectively or combinedly associated with the inspection target.

12. The defect inspection apparatus according to claim 11, wherein the plurality of multi-core processors are connected to the dividing part via a scalable common bus or a communication unit of a network, and a combination of a network and the bus, and
the number of multi-core processors is variable.

13. An image processor used in a defect detection apparatus comprising:
a dividing part for dividing image data taken by an imaging unit into a plurality of image data blocks; and
a parallel processing unit including a plurality of multi-core processors each having a plurality of cores and parallelly performs a defect detection processing for a defect in a pattern formed on a sample with respect to each of the plurality of image data blocks, wherein
the plurality of cores include operation cores for executing the defect detection processing of the image data blocks and control cores for receiving the image data blocks from the dividing part, and
the image data block to which the operation core performs the defect detection processing is prepared by the control core.

14. The image processor according to claim 13, wherein
the imaging unit is composed of a plurality of sensors arranged in a plurality of directions with respect to the sample, and
the defect detection apparatus further comprising:
a memory part for storing data of a plurality of dark-field images acquired by scanning the sample at least once, wherein
the dividing part transmits any of the plurality of dark-field image data in a packet,
the packet includes first dark-field image data and second dark-field image data,
the multi-core processor receives the packet,
the multi-core processor has a first operation core and a second operation core, and
the first operation core or the second operation core makes alignment between the first dark-field image data and the second dark-field image data.

15. The image processor according to claim 14, wherein
the first dark-field image data and the second dark-field image data are involved with a first die,
the packet further includes third dark-field image data which are acquired by the first sensor involved with a die adjacent to the first die, and forth dark-field image data acquired by the second sensor,
the first operation core aligns a location of the first dark-field image data with a location of the second dark-field image data, and
the second operation core aligns a location of the first dark-field image data with a location of the second dark-field image data.

16. The image processor according to claim 15, wherein
the first operation core performs pieces of the defect detection processing for the first dark-field image data and the second dark-field image data which have been aligned with each other,
the second operation core performs pieces of the defect detection processing for the third dark-field image data and the forth dark-filed image data which have been aligned with each other.

17. The image processor according to claim 15 further comprising another multi-core processor connected via a network, wherein another multi-core processor performs pieces of the defect detection processing for the first dark-field image data and the second dark-field image data which have been aligned with each other.

18. The image processor according to claim 15 further comprising other multi-core processors connected via a network, wherein the other multi-core processors perform pieces of the defect detection processing for the third dark-field image data and the forth dark-field image data which have been aligned with each other.
